(19) United States
(12) Patent Application Publication
(10) Pub. No.: US 2002/0140655 A1
(43) Pub. Date: Oct. 3, 2002

(54) Pixel driving module of liquid crystal display

(76) Inventors: Wei-Chen Liang, Hsinchu (TW); Pin Chang, Hsinchu (TW); Heng-Chung Wu, Hsinchu Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/033,964

(22) Filed: Jan. 3, 2002

(30) Foreign Application Priority Data
Apr. 3, 2001 (TW) 90205162

(51) Int. Cl. G09G 3/36

(52) U.S. Cl. 345/89

(57) ABSTRACT

The present invention provides a pixel driving module of a liquid crystal display, wherein a display panel thereof is formed by uniformly and alternately arranging a plurality of sub-pixels selected from the three primary colors of red, blue, and green in mosaic, turtleback, or checker form. The pixel driving module connects each transversal row of sub-pixels together with a parallel signal scan line. Each of the data transmission lines forms an indent strike to longitudinally connect in order a sub-pixel in every two adjacent transversal rows together. The present invention has the advantages of shrinking the pitch of sub-pixels, increasing the area and window ratio of display pixels, enhancing the resolution of the display, and reducing the impedance of the driving module.

### FIELD OF THE INVENTION

The present invention relates to a liquid crystal display and, more particularly, to a pixel driving module of liquid crystal display.

### BACKGROUND OF THE INVENTION

Displays are inevitable equipments of the present information society. They play the roles as output devices for showing pictures and texts. In a display, an image output is composed of many pixels of different colors and brightness. Each pixel comprises a plurality of sub-pixels. The smaller the shortest distance between two adjacent sub-pixels (i.e., a pitch), the sharper the frame of the display.

In a common display, each pixel is composed of three sub-pixels respectively of the three primary colors—red, green, and blue. Each sub-pixel is driven by a signal scan line (Common) and a data transmission line (Segment) to control the bright and dark states thereof. Full-color mode is achieved by mixing the three primary colors according to proportion. In a prior art liquid crystal display, when a plurality of sub-pixels 12 respectively having the red (R), blue (B), and green (G) colors are arranged in mosaic form, a pixel driving module 10 thereof is as shown in FIG. 1. Data transmission lines 14 are longitudinally and parallel arranged, and each data transmission line 14 needs to pass through a pitch 18 between two adjacent transversal rows of sub-pixels 12 so as to connect the longitudinally spaced sub-pixels 12. The transversal rows of sub-pixels 12 are connected together via a parallel signal scan line 16. The data transmission lines 14 and the signal scan lines 16 are then connected with driving elements disposed at edges of the display. Driving signals are controlled via the driving elements to fast and repetitively scan each sub-pixel 12 for forming a frame. This kind of design of the data transmission lines 14 lets a certain space need to be pre-reserved between adjacent sub-pixels 12 to be passed by the data transmission line 14 when laying out the sub-pixels 12 on a panel of the display. Therefore, the pitch 18 between adjacent sub-pixels 12 cannot be shrunk. In addition to not achieving better sharpness for images of the frame of the display, the area of display pixels is limited and the window ratio is reduced, hence greatly lowering the resolution of the display. Moreover, this kind of layout of the data transmission lines 14 not only lets the driving module have higher impedance, but also easily causes distortion of signals, and generates serious indents for the display of slanting lines, resulting in bad display effect. Accordingly, the present invention aims to propose an improved layout of the data transmission lines of the pixel driving module.

### SUMMARY OF THE INVENTION

The primary object of the present invention is to propose a pixel driving module capable of increasing sharpness of images of a display and increasing the area and window ratio of display pixels so as to enhance the resolution of the display.

Another object of the present invention is to propose a pixel driving module capable of reducing impedance and improving distortion of signals.

Yet another object of the present invention is to propose a pixel driving module to lessen the indent problem of slanting lines on display.

According to the present invention, a plurality of sub-pixels of colors selected from the red, blue, and green colors are alternately arranged on a liquid crystal display panel in mosaic, turtleback, or checker form. A pixel driving module thereof connects transversal rows of sub-pixels together with a parallel signal scan line. The data transmission lines form an indent strike to longitudinally connect in order a sub-pixel in every two adjacent transversal rows together.

The various objects and advantages of the present invention will be more readily understood from the following detailed description when read in conjunction with the appended drawings, in which:

### BRIEF DESCRIPTION OF THE DRAWINGS

FIG. 1 is a diagram of a prior art pixel driving module;

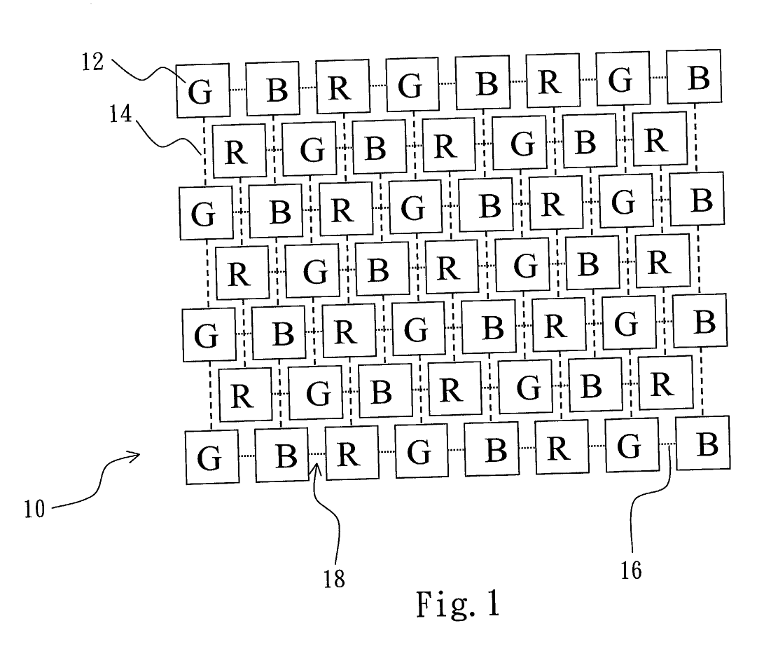

FIG. 2 is a diagram of a pixel driving module of the present invention;

FIG. 3 is a diagram according to another embodiment of the present invention; and

FIG. 4 is a diagram according to yet another embodiment of the present invention.

### DETAILED DESCRIPTION OF THE PREFERRED EMBODIMENTS

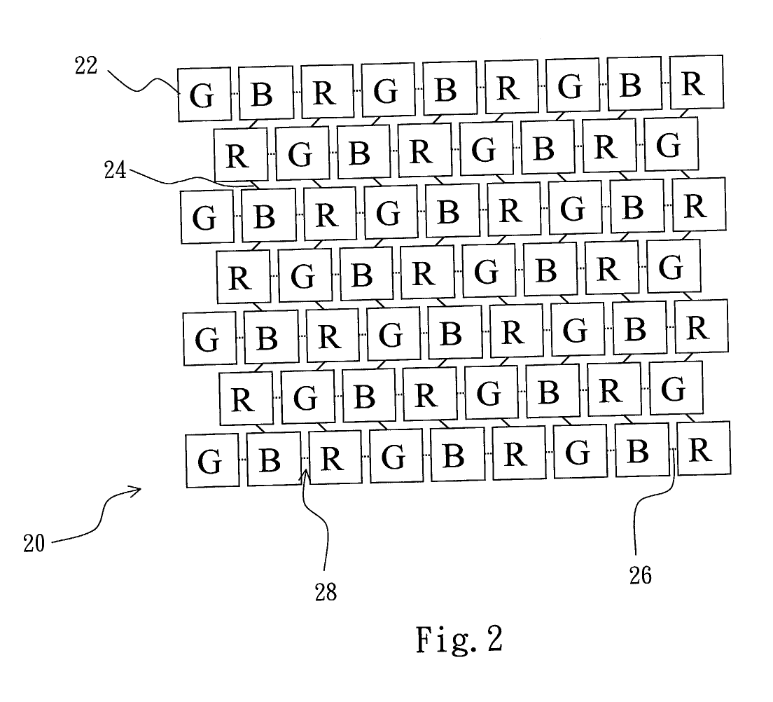

As shown in FIG. 2, a panel of a liquid crystal display is formed by uniformly and alternately arranging several sub-pixels 22 selected from the red (R), green (G), and blue (B) colors in mosaic form. In every two adjacent rows of sub-pixels 22, each pixel 22 in one row of sub-pixels 22 is disposed between two sub-pixels 22 of the other adjacent row of sub-pixels 22. The bright or dark state of each sub-pixel 22 is controlled by data transmission lines 24 and signal scan lines 26 of a pixel driving module 20. The signal scan lines 26 are parallel disposed to respectively connect each transversal row of sub-pixels 22. The data transmission lines 24 form an indent strike to longitudinally connect a sub-pixel 22 in order in every two adjacent transversal rows.

The above data transmission lines 24 and the signal scan lines 26 are modules composed of an upper layer and a lower layer of indio tin oxide (ITO), respectively. They are uniformly disposed on transparent electrode plates inside the liquid crystal display. When a voltage signal is applied to the liquid crystal display, the sub-pixels 22 will be controlled by the signal scan lines 26 and the data transmission lines 24 and match the arrangement of liquid crystal molecules so as to show bright or dark points. Color brightness and gray scale contrasts of the sub-pixels 22 are further controlled according to the magnitude of the voltage signal. The effect of a series of different colors can thus be obtained by assembly and variation of colors of the sub-pixels 22.

In the above sub-pixels 22 arranged in mosaic form, because the data transmission lines 24 are used to connect in order two adjacent rows of sub-pixels 22, it is not necessary to pre-reserve a space between two sub-pixels 22 for passage of the data transmission lines 24 to shrink a pitch 28 between the sub-pixels 22 to minimum, hence obtaining a very good sharpness of frame and increasing the area and window ratio of display pixels. The resolution of the display can thus be enhanced. Moreover, the layout of the data transmission lines 24 has the advantage of reducing impedance to avoid signal distortion.

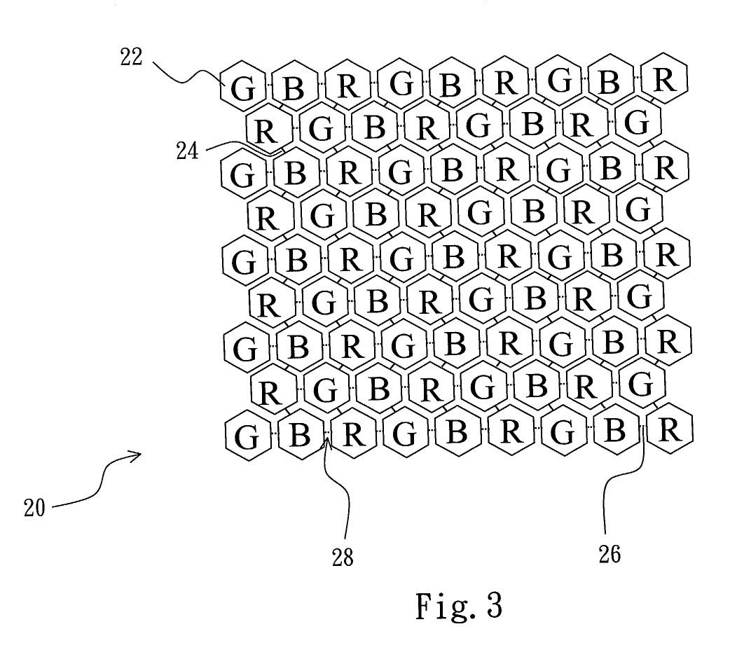

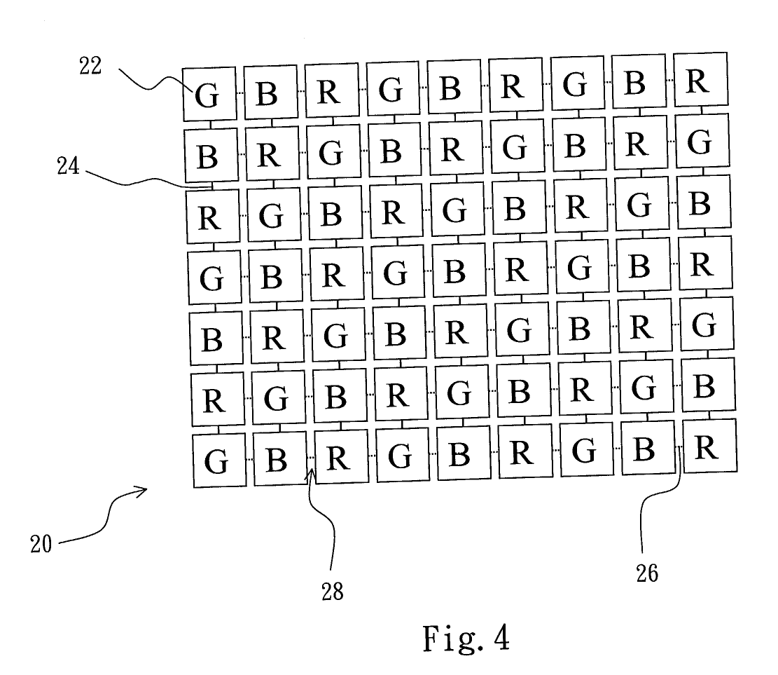

FIG. 3 shows another embodiment of the present invention. The sub-pixels 22 are uniformly and alternately arranged in turtleback form. The data transmission lines 24 are used to longitudinally connect in order two adjacent sub-pixels 22. In addition to having the advantages of shrinking the pitch 28 to minimum and increasing the area of display pixels and reducing impedance, this kind of layout can further improve the indent distortion problem of slanting lines on display, and enhance fineness of lines and accuracy of image display, thereby meeting the requirements of delicacy and sharpness of lines for display of texts and patterns. Furthermore, the connection way of the data transmission lines 24 of the present invention can apply for sub-pixels 22 arranged in checker form so as to connect in order each longitudinal row of sub-pixels 22, as shown in FIG. 4. In addition to having the advantages of shrinking the pitch 28 and reducing impedance, this kind of layout can improve the problem of easy skewness of typeface for display of texts, hence letting the display of typeface be more beautiful and neat.

Therefore, when the present invention is applied to electronic products for displaying images and pictures (e.g., digital still cameras and video cameras with screens attached), the layout of data transmission lines thereof will let the image be sharp and distortionless.

For the arrangement of the above sub-pixels 22, in every two adjacent longitudinal rows of sub-pixels 22, each sub-pixel 22 of one longitudinal row is disposed between two sub-pixels 22 of the other adjacent longitudinal row to let each signal scan line 26 uniformly show an indent strike so as to connect in order a sub-pixel 22 in every two longitudinal rows.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A pixel driving module of a liquid crystal display for controlling the brightness and gray-scale contrast of a plurality of sub-pixels selected from three colors to let said liquid crystal display achieve full-color display, said plurality of sub-pixels of different colors being uniformly arranged, each said sub-pixel of one of every two adjacent transversal rows of said sub-pixels being disposed between two said sub-pixels of the other adjacent transversal row, each said sub-pixel being driven by a transversal signal scan line and a longitudinal data transmission line simultaneously, each said data transmission line uniformly showing an indent strike to connect in order one said sub-pixel in every two transversal rows together.

2. The pixel driving module of a liquid crystal display as claimed in claim 1, wherein each said sub-pixel of one longitudinally row of every two adjacent longitudinal rows of said sub-pixels is disposed between two said sub-pixels of the other adjacent longitudinal row, each said signal scan line uniformly showing an indent strike to connect in order one said sub-pixel in every two adjacent longitudinal rows together.

3. The pixel driving module of a liquid crystal display as claimed in claim 1, wherein said signal scan lines and said data transmission lines are modules composed of transparent conductive films of indio tin oxide.

4. The pixel driving module of a liquid crystal display as claimed in claim 1, wherein said three colors are red, blue, and green colors, respectively.

5. The pixel driving module of a liquid crystal display as claimed in claim 1, wherein said sub-pixels of different colors are arranged in mosaic, turtleback, or checker form.
